(19) United States
(12) Patent Application Publication
(10) Pub. No.: US 2008/0298359 A1
(43) Pub. Date: Dec. 4, 2008

(54) SELECTION METHOD FOR MESSAGE PATHS IN COMMUNICATION SYSTEMS

(75) Inventor: Michael Tuxen, Steinfurt (DE)

Correspondence Address: BELL, BOYD & LLOYD, LLP, P.O. BOX 1135, CHICAGO, IL, 60690, US

(73) Assignee: Siemens Aktiengesellschaft, Muenchen (DE)

(21) Appl. No.: 12/113,685

(22) Filed: May 1, 2008

Related U.S. Application Data
(63) Continuation of application No. 10/925,202, filed on Aug. 24, 2004, now abandoned.

(30) Foreign Application Priority Data
Aug. 26, 2003 (DE) 10339280.7

(51) Int. Cl. H04L 12/28

(52) U.S. Cl. 370/389

(57) ABSTRACT

In multilink capable transport protocols, e.g. Stream Control Transmission Protocol SCTP, several paths or links exist between two endpoints (110, 120). Whilst a communication system (100) is operating with this type of transport protocol, situations arise wherein a path (140,142) must be selected for the transmission of messages, such as if for reasons of redundancy a message should be transmitted on different paths (140,142), or when a path (140) is disturbed and the object is to select a path (142) suitable for the message repetition. In accordance with the invention, it is provided that a further path (142) to the base path (140) is to be selected between a first (110) and a second (120) network element according to the following steps: determining an address (126B) of the second network element (120), said address characterizing the base path (140) for the transmission of messages from the first network element (110) to the second network element (120); determining the level of the address, characterizing the base path (140), of the second network element (120); determining a further address (128B) of the second network element (120) with the same level; and selecting the path, characterized by the further address (128B), for the transmission of messages from the first network element (110) to the second network element (120).

### CROSS REFERENCE TO RELATED APPLICATIONS

This application claims priority to the German application No. 10339280.7, filed Aug. 26, 2003 and which is incorporated by reference herein in its entirety.

### FIELD OF INVENTION

The invention relates to a selection method for message paths in communication systems.

### BACKGROUND OF INVENTION

Several paths and/or links exist between two endpoints in what are termed as multilink capable transport protocols. An example of a multilink capable transport protocol is the Stream Control Transmission Protocol, which is defined in IETF RFC 2960.

Whilst a communication system is operating with this type of transport protocol, situations arise wherein a path must be selected for the transmission of messages.

An example of this is when a message is transmitted several times on different paths for reasons of redundancy. The object is to suitably select the other paths based on a base path selected, for example, by means of a method implemented in the protocol stack.

Another case in which the path selection is important is when a path is subject to interference and the task is then to select a path suitable for the message repetition.

### SUMMARY OF INVENTION

The object of the invention is thus to specify a method by means of which message paths for redundant transmission or repeat transmission can be selected in such a way that the selected path differs as much as possible from a base path.

This object is achieved by the claims. Preferred embodiments can be drawn from the dependent claims.

In accordance with the invention, a further path is to be selected for a base path between a first and a second network element, according to the following steps:

Determining an address of the second network element which characterizes the base path for the transmission of messages from the first network element to the second network element.

Determining the level of the address characterizing the base path of the second network element

Determining a further address of the second network element with the same level, and

Selecting the path characterized by the further address, for the transmission of the messages from the first network element to the second network element.

The base path can be a base path for a redundant transmission, for which a further path is determined. The method is also advantageously applicable when a different path from the base path is determined for the repetition of the message transmission, subsequent to the determination that a base path has failed.

Repeating the method allows several paths to be determined for a base path.

The advantage of the method lies in the fact that the selection of a new path based on the level of the address characterizing the path supplies a path which “differs as far as possible” from the base path, for example, which physically reaches the destination via another route.

If this method is used to select a path for a repetition of messages, in the case of a physically failed base path, a path is thus selected which is physically intact.

If this method is used to select a redundant path for an intact base path, the method ensures the redundancy is as great as possible, so that the destination is reached on physically different routes.

This advantage is based on the fact that several addresses are frequently assigned in modem communication systems to physical interfaces of a network element, which in turn can be divided into different levels. Furthermore, network elements frequently comprise several physical interfaces, so that two basic categories of address result; addresses which characterize “physically” disjointed paths and which are assigned to different interfaces, and level-disjointed addresses, which are assigned different levels but can be assigned to the same physical interfaces.

By selecting the path on the basis of an address with the same level, a physically disjointed path is chosen, which cannot be achieved by means of other selection methods.

With regards to network elements, wherein individual interfaces have several addresses of the same level, wherein two different addresses of the same level do not necessarily characterize physically disjointed paths, the seek time is nevertheless reduced when searching for replacement paths for a failed base path, since the probability that a selected address of the same level characterizes a physically disjointed path is considerably higher than if the level of the addresses is not taken into account.

An exemplary embodiment of the invention is described in more detail below with reference to the drawings.

### BRIEF DESCRIPTION OF THE DRAWING

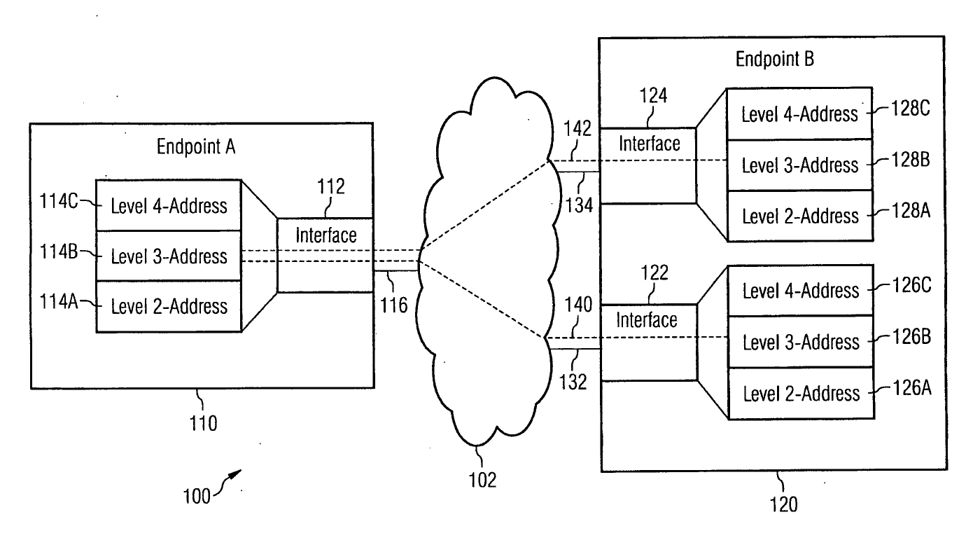

The single FIG. 1 shows a schematic representation of a communication system 100 with a first network element 110 (Endpoint A) and a second network element 120 (Endpoint B) as well as a transport network 102 linking both network elements 110, 120.

### DETAILED DESCRIPTION OF INVENTION

The assumption is made that both network elements 110, 120 are SCTP endpoints. To facilitate the representation, only one first interface 112 is represented for the first network element 110, the first network element 110 being connected to the transport network 102 via said first interface 112 by means of a first connection 116. Furthermore, the first network element 110 can have further interfaces and connections with the transport network or with other transport networks (not shown).

The first network element 110 has three addresses 114A-C, which are assigned physically to the first interface 112. By way of example, these are a Level2 address 114A, a Level3 address 114B, and a Level4 address 114C which unambiguously address the first network element 110 within their field of validity, but nevertheless do not address it one to one.

The second network element 120 was represented for example with two physically different interfaces 122, 124. A second interface 122 connects the second network element 110 by means of a second connection 132 with the transport network 102, and a third interface 124 connects the second network element 110 by means of a third connection 134 with the transport network 102. Furthermore, the second network element 120 can comprise further interfaces and connections with the transport network or with other transport networks (not shown).

The second network element 110 has three addresses 126A-C, which are physically assigned to the second interface 122. For example, a Level2 address 126A, a Level3 address 126B and a Level4 address 126C unambiguously address the second network element 120 within their scope of validity, but nevertheless do not address it one to one.

Furthermore, the second network element 110 has three further addresses 128A-C, which are physically assigned to the third interface 124. For example, a Level2 address 128A, a Level3 address 128B and a Level4 address 128C unambiguously address the second network element 120 within the field of their validity, but nevertheless do not address it one to one.

Six possible addresses exist whereby the second network element 120 can be addressed. Three addresses each address the same physical interface. If the path 140 characterized by the Level3 address 126B is considered the base path (illustrated with a dashed line), the selection of the paths characterized (not shown) by the addresses 126A and 126C would address the same physical interface 122 of the second network element, whereby no redundancy gain is effected and whereby a similarly faulty path was selected when the second interface 122 or the second connection 132 fails.

In contrast, the selection according to the invention of a further Level3 address of the second network element, e.g. here the selection of the Level3 address 128B, leads in the present configuration immediately to the selection of a physically disjointed path 142 (again illustrated with a dashed line), which is routed via the third interface 124 and the third connection 134.

If the addresses used in the communication system are IP addresses, the levels for IPv4 are defined as follows by means of the IETF Internet Draft draft-stewart-tsvwg-sctpipv4-00.txt, published on May 17.sup.th 2002:

Level0: Addresses which cannot be used for SCTP, for example 0.0.0.0/8, 224.0.0.0/4, 198.18.0.0/24, 192.88.99.0/24

Level1: Loopback addresses, for example 127.0.0.0/8

Level2: Link-local addresses, for example 169.254.0.0/16

Level3: Private addresses, for example, 10.0.0.0/8, 172.16.0.0/12, 192.168.0.0/16

Level4: Global addresses

The following determinations are valid for SCTP: Addresses with Level0 may not be used:

as a source address of an SCTP packet

as a destination address of an SCTP packet, and

within an address parameter of an INIT chunk or an INIT-ACK chunk

Furthermore, definitions are made by means of draft-stewart-tsvwg sctpipv4-00.txt for SCTP INIT chunks and SCTP INIT-ACK chunks, on the basis of which the respective recipient of INIT chunks and INIT-ACK chunks can determine all addresses of the respective sender which can be used for a communication.

Naturally other assignments of addresses to levels are possible in relation to the present invention. Similarly, the exchange of all addresses useful for communication can be effected between communication partners by means of other mechanisms.

All that is important for the present invention is that a transmitting endpoint knows the destination addresses available.

If the assumption is for example made that the first SCTP endpoint A initiates the connection by means of INIT to the second SCTP endpoint B, and the first SCTP endpoint A uses the Level3 address 126B of the SCTP endpoint, perhaps because the Level2 addresses 114A, 126A and 128A are not routed through the transport network 102, the SCTP endpoint B then knows the addresses under which SCTP endpoint A can be reached from SCTP endpoint B, namely Level3 address 11 4B and Level4 address 114C, but not Level2 address 114A.

The connection request is thus confirmed by means of INIT-ACK through SCTP endpoint B, wherein the SCTP endpoint B informs SCTP endpoint A of all suitable addresses for addressing the SCTP endpoint B, here Level3-addresses 126B and 128B and the Level4 addresses 126C and 128C. These can be stored in the form of a table in the SCTP endpoint A.

Similar mechanisms are also provided for IPv6.

If the path 140 originally selected by SCTP endpoint A is disturbed by a failure in the second connection 132 or the second interface 122, SCTP endpoint A selects, for further communication with the SCTP endpoint B, from the stock of 4 addresses as follows:

the base path characterized by address 126B was identified as having failed. The address 126B is thus unsuitable. The level of the address 126B is Level3.

Address 126C is an address with a different level. The path characterized by this address is thus not selected.

Address 128B is an address with the same level. The path characterized by this address is selected.

Address 128C does not have to be examined, since a path was already found. If the seek sequence is another, it is established that address 128C is also an address with a different level. The path characterized by this address is thus not selected.

If several addresses in the same level and thus several paths are available, any of these can be selected. Alternatively, further criteria can be used in order to select a path which is as different as possible, for example, the numerical distance between an address and the address of the base path. The background is that in one configuration wherein the second interface 122 has two Level3 addresses (not shown), the selection of the second Level3 address of the second interface would not lead to the destination. It is assumed in practice that the second Level3 address of the second interface lies numerically nearer to the first Level3 address of the second interface than the level3 address of the third interface, so that this can be used as an additional criterion.

1-5. (canceled)

6. A method for selecting paths for transmitting messages from a first network element of a communication system to a second network element of the communication system, the method comprising:
determining an address of the second network element, said address characterizing a base path for transmitting messages from the first network element to the second network element;
determining a level of the address, characterizing the base path, of the second network element;
determining a further address of the second network element with the same level; and
selecting the path, characterized by the further address, for transmitting messages from the first network element to the second network element.

7. The method according to claim 6, wherein the base path is determined as a path, via which a previous transmission of messages from the first network element to the second network element has failed.

8. The method according to claim 6, wherein the addresses are IP addresses.

9. The method according to claim 7, wherein the addresses are IP addresses.

10. The method according to claim 6, wherein the transmission of messages in the communication system is accomplished in a manner consistent with the Stream Control Transmission Protocol SCTP.

11. The method according to claim 7, wherein the transmission of messages in the communication system is accomplished in a manner consistent with the Stream Control Transmission Protocol SCTP.

12. The method according to claim 8, wherein the transmission of messages in the communication system is accomplished in a manner consistent with the Stream Control Transmission Protocol SCTP.

13. The method according to claim 6, wherein the further address of the second network element is taken from a table held in the first network element, and wherein the table comprises all addresses of the second network element and their associated levels.

14. The method according to claim 7, wherein the further address of the second network element is taken from a table held in the first network element, and wherein the table comprises all addresses of the second network element and their associated levels.

15. The method according to claim 8, wherein the further address of the second network element is taken from a table held in the first network element, and wherein the table comprises all addresses of the second network element and their associated levels.

16. The method according to claim 10, wherein the further address of the second network element is taken from a table held in the first network element, and wherein the table comprises all addresses of the second network element and their associated levels.

17. The method according to claim 6, wherein the transmission of messages in the communication system is accomplished by the Stream Control Transmission Protocol SCTP.
